(19) United States
(12) Patent Application Publication
(10) Pub. No.: US 2020/0040149 A1
(43) Pub. Date: Feb. 6, 2020

(54) POLYMER-CERAMIC HYBRID FILM HAVING MECHANICAL PROPERTIES AND ELASTICITY, AND METHOD FOR MANUFACTURING SAME

(71) Applicant: Foundation for Research and Business, Seoul National University of Science and Technology, Nowon-gu Seoul (KR)

(72) Inventors: Insup Noh, Dobong-gu, Seoul (KR); Das Dipankar, Nowon-gu, Seoul (KR); Sumi Bang, Namyangju-si Gyeonggi-do (KR)

(21) Appl. No.: 16/340,068

(22) PCT Filed: Apr. 14, 2017
(86) PCT No.: PCT/KR2017/004047

§ 371 Date: Apr. 5, 2019

(30) Foreign Application Priority Data
Oct. 6, 2016 (KR) 10-2016-0128796
Oct. 6, 2016 (KR) 10-2016-0128802
Oct. 6, 2016 (KR) 10-2016-0128807
Mar. 2, 2017 (KR) 10-2017-0027300
Mar. 2, 2017 (KR) 10-2017-0027301
Mar. 2, 2017 (KR) 10-2017-0027302

(51) Int. Cl. C08J 5/18; C08L 5/04; C08J 3/24

(52) U.S. Cl. CPC C08J 5/18; C08K 3/32; C08J 3/24; C08L 5/04

(57) ABSTRACT

The present invention relates to a polymer-ceramic hybrid film and a method for manufacturing same. The polymer-ceramic hybrid material according to the present invention, which is an elastic polymer-ceramic hybrid film, can maintain a film form for a long time while realizing excellent elasticity and mechanical properties at the same time, and thus can be applied as a medical material such as a patch. Also, a hydrogel used in the manufacturing process of the film can be very usefully utilized as a material for 3D printing. The mechanical strength and elasticity of the polymer-ceramic hybrid film according to the present invention can be improved by varying the arrangement of ceramic particles within the hybrid material by varying the processing process of a hybrid solution.

### CROSS-REFERENCE TO RELATED APPLICATIONS

This application is a national phase entry under 35 U.S.C. § 371 of International Patent Application PCT/KR2017/004047, filed Apr. 14, 2017, designating the United States of America and published as International Patent Publication WO 2018/066780 A2 on Apr. 12, 2018, which claims the benefit under Article 8 of the Patent Cooperation Treaty to Korean Patent Application Serial Nos. 10-2016-0128796, 10-2016-0128802, and 10-2016-0128807, all filed Oct. 6, 2016, and to Korean Patent Application Serial Nos. 10-2017-0027300, 10-2017-0027301, and 10-2017-0027302, all filed on Mar. 2, 2017.

### TECHNICAL FIELD

Example embodiments relate to a polymer-ceramic hybrid film having mechanical properties and elasticity and a method for manufacturing the same.

### BACKGROUND

Research is being actively conducted to create hybrid materials for ceramics (inorganic materials), metals and polymeric materials that have been classified as current traditional materials. A hybrid as a material means that two or more materials, such as inorganic materials, metals, polymers, and the like, that are regarded to be different in kind from each other are implemented in a single system, to have a synergistic effect for a new performance while maintaining their performances.

Among hybrid materials, hybrid materials of polymers and ceramics are attracting the greatest attention. Polymers mainly mean materials formed by a chain reaction of carbon, and may be classified as a kind of organic materials, and ceramic materials refer to a kind of inorganic materials, for example, oxides of metal ions, such as titanium dioxide (TiO2), silicon dioxide (SiO2), and the like, hydroxides, carbonates, phosphates, and the like. Organic materials and inorganic materials are regarded not to be mixed well because they are different from each other in various aspects, for example, binding properties, physical properties, and the like, the organic materials and inorganic materials are regarded not to be properly mixed with each other. However, in fact, so-called “polymer-ceramic hybrid materials” in which polymers and inorganic materials are mixed together are frequently found in nature. A skeleton that maintains a skeleton of a human body is an inorganic material of hydroxyapatite (HAP), and muscular tissues and soft tissues include organic materials of collagen and polysaccharide, and accordingly the human body may be regarded as a huge hybrid of organic materials and inorganic materials. Also, most of materials that form egg shells of a bird are calcium carbonate (calcite) that is a hybrid material with an inner surface that is attached to a polymeric membrane.

A wide variety of polymeric materials and ceramics may be used as hybrid materials. However, when focusing on a field of medical materials, both a polymer and ceramic need to have biosafety and biocompatibility. To this end, biogenic polymers or easily decomposable polymers are suitable as polymers, a ceramic material is also a biogenic inorganic material or is easily decomposed in vivo, and it is desirable that degradation products do not have toxicity to a living body. Representative medical natural polymeric materials include, for example, agarose, pectin, carrageenan, chitosan, alginate, gelatin, collagen and chondroitin sulfate, and the like. Also, ceramic materials are compounds that are highly likely to be used as medical materials or biological applications, and hydroxyapatite is an important component that forms a skeleton of a human body and is an important material in the study on tissue engineering, artificial biomaterials, and the like. Recently, clays or layered metal hydroxides are being actively studied for drug delivery system.

Also, when a polymer-ceramic hybrid material is used as a medical material, as described above, mechanical properties capable of being laminated are required, to apply the polymer-ceramic hybrid material to a damaged area requiring a constant load for a certain period of time, or to a field of 3D bioprinting that needs to maintain a predetermined shape after molding. A film having flexibility (for example, elasticity, and the like) to cover a complex tissue and an organ of a patient is required, and a polymer-ceramic hybrid material is generally manufactured in a form of a gel or a particle. However, different forms and surface characteristics are required to widely apply hybrid materials to fields, such as medical fields or complex types of tissues and organs. For example, hydrogels, films and other forms with flexibility and strength are required, and biocompatibility to interact with surrounding tissues of a patient when used for medical applications is required.

Also, when a polymer-ceramic hybrid material is prepared, a process, such as a chemical reaction induction, is included, which leads to an inconvenience in terms of a manufacturing method, such as, a high temperature, a high pressure, or applying of a cross-linking agent, an initiator, and the like. In this regard, research is being conducted to control physical properties of a film by adjusting process conditions in a film manufacturing process.

Thus, research has been actively conducted on various physical properties and shapes of polymer-ceramic hybrid materials, and on manufacturing methods (Syntheses and Characterizations of Polymer-Ceramic Composites Having Increased Hydrophilicity, Air-Permeability, and Anti-Fungal Property (Journal of the Korean Chemical Society, 2010)), and related technologies have been proposed in Korean Patent Registration Publication Nos. 10-1360942 and 10-1328645.

Korean Patent Registration Publication No. 10-1360942 discloses a method of manufacturing a cell-contained biocompatible polymer-natural biocompatible material hybrid structure, and the method includes step (a) of forming a polymer strut layer by distributing side by side two or more biocompatible polymer struts on a plate; step (b) of distributing side by side biocompatible polymer struts at intervals in a direction intersecting a direction of the distributed biocompatible polymer struts on the distributed biocompatible polymer strut layer; step (c) of distributing a strut formed of one or more natural biocompatible materials selected from the group consisting of cell-contained gelatin, fucoidan, collagen, alginate, chitosan and hyaluronic acid between the biocompatible polymer struts distributed in step (b) so as not to be in contact with the biocompatible polymer struts, and forming a cross-linkage to the natural biocompatible material; and step (d) of forming a hybrid structure by sequentially repeating steps (b) and (c).

Korean Patent Registration Publication No. 10-1328645 discloses a method for producing a nano/micro hybrid fiber nonwoven fabric, and the method includes step a) of preparing each solution by dissolving two different types of biodegradable polymers in an organic solvent; step b) of producing a nano/micro hybrid fiber sheet by simultaneously spinning nanofibers and microfibers of each of the biodegradable polymers in both directions using an electrospinning method in each of the prepared solution; and step c) removing the residual solvent of the produced hybrid fiber sheet.

However, although some extent of physical properties required for polymer-ceramic hybrid materials manufactured in each of Korean Patent Registration Publication Nos. 10-1360942 and 10-1328645 is achieved, it is impossible to perform a manufacturing process at room temperature and in particular, it is impossible to manufacture a polymer-ceramic hybrid in a form of a film with adjusted flexibility and mechanical properties.

Thus, there is a desire for development of a technology of manufacturing polymer-ceramic hybrid materials with elasticity and flexibility in forms of films using a simple manufacturing method, and development of a process technology of manufacturing a film instead of using a cross-linking agent or an initiator at room temperature.

### BRIEF SUMMARY

### Technical Subject

The present inventors have tried to develop a new polymer-ceramic hybrid material with elasticity to solve the aforementioned problems of the related arts, and as a result of these research efforts, it is confirmed based on data that it is possible to adjust flexibility and mechanical properties that are physical properties required for the polymer-ceramic hybrid material when a mixing ratio of a polymer and ceramic is adjusted within a specific range or when a corresponding process condition is adjusted. In particular, it is confirmed that a shape of a film with excellent elasticity and/or mechanical properties is manufactured when an aqueous solution containing a specific ion, such as calcium chloride, is cured under a specific process condition, in manufacturing of the polymer-ceramic hybrid material, and a chemical mechanism and process conditions thereof are verified, to complete the present disclosure.

The present disclosure provides a polymer-ceramic hybrid film and a method for manufacturing the same.

### Solutions

According to an aspect, there is provided a polymer-ceramic hybrid film including: a biocompatible polymer including a carboxyl group and a hydroxyl group; calcium phosphate; and a divalent metal ion.

The biocompatible polymer and the calcium phosphate may be mixed at a weight ratio of 20:1 to 8:1.

The biocompatible polymer and the calcium phosphate may be mixed at a weight ratio of 5:1 to 1:1.

The biocompatible polymer and the calcium phosphate may be mixed at a weight ratio of 1:2 to 1:20.

The biocompatible polymer may be alginate.

A hydroxyl group of the alginate may be cross-linked with the calcium phosphate.

The calcium phosphate may be tricalcium phosphate (TCP).

A carboxyl group of the alginate may be cross-linked with the divalent metal ion.

The divalent metal ion may be a calcium ion (Ca²⁺).

The polymer-ceramic hybrid film may exhibit pH-dependent drug release properties.

According to another aspect, there is provided a method for manufacturing a polymer-ceramic hybrid film, the method including: step (a) of preparing a hybrid solution in which a biocompatible polymer including a carboxyl group and a hydroxyl group is mixed with calcium phosphate; step (b) of inducing an arrangement of particles in the hybrid solution; and step (c) of mixing the hybrid solution with a divalent metal ion solution.

The biocompatible polymer and the calcium phosphate may be mixed at a weight ratio of 20:1 to 8:1.

The biocompatible polymer and the calcium phosphate may be mixed at a weight ratio of 5:1 to 1:1.

The biocompatible polymer and the calcium phosphate may be mixed at a weight ratio of 1:2 to 1:20.

The biocompatible polymer may be alginate.

A hydroxyl group of the alginate may be cross-linked with the calcium phosphate.

Step (b) may include screeding the hybrid solution on a support.

A screeding speed may be in the range of 5 cm²/s to 10 cm²/s.

The divalent metal ion solution may have a concentration of 0.05 M to 5 M.

A carboxyl group of the alginate may be cross-linked with the divalent metal ion.

### Effects

According to example embodiments, a polymer-ceramic hybrid material as a polymer-ceramic hybrid film, may maintain a film shape for a long period of time while realizing excellent elasticity and/or mechanical properties, and thus may be applied as a medical structure or a food package container. Also, a hydrogel used in a process of manufacturing the film may be very usefully utilized as a material for three-dimensional (3D) printing.

According to example embodiments, elasticity and mechanical properties of a polymer-ceramic hybrid film may be adjusted by adjusting an arrangement of ceramic particles within a hybrid material based on a process of a hybrid solution. Also, a method for manufacturing a polymer-ceramic hybrid film includes only simple and easy manufacturing steps and may allow for the manufacture of a polymer-ceramic material even at room temperature.

It should be understood that the effects of the present disclosure are not limited to the effects described above, but include all effects that can be deduced from the detailed description of the present disclosure or composition of the invention set forth in the claims.

### BRIEF DESCRIPTION OF THE DRAWINGS

FIG. 1 illustrates photographs of a method for elasticity evaluation according to an example embodiment;

FIG. 2 illustrates a photograph of a method for evaluation of mechanical properties according to an example embodiment;

FIG. 3 illustrates photographs of hybrid films of examples and a comparative example according to an example embodiment;

FIG. 4 illustrates photographs of hybrid films of examples according to an example embodiment;

FIG. 5 illustrates photographs of hybrid films of examples according to an example embodiment;

FIG. 6 illustrates photographs of hybrid films of examples according to an example embodiment;

FIG. 7 is a photograph showing that a shape of a hybrid film according to an example embodiment is maintained even after 12 days elapsed;

FIG. 8 illustrates a photograph of a process of manufacturing a hybrid film and an arrangement of particles in a film according to an example embodiment;

FIG. 9 illustrates ATR-FTIR analysis results of hybrid films according to an example embodiment;

FIG. 10 illustrates ¹³C NMR analysis results of hybrid films according to an example embodiment;

FIG. 11 illustrates XRD analysis results of hybrid films according to an example embodiment;

FIG. 12 illustrates TGA analysis results of hybrid films according to an example embodiment;

FIGS. 13A, 13B and 13C illustrate SEM images of hybrid films according to an example embodiment, and FIGS. 13D, 13E and 13F illustrate FESEM images of the hybrid films;

FIG. 14 is a graph illustrating a correlation between an elongation rate and a tensile strength of hybrid films according to an example embodiment;

FIGS. 15A, 15B and 15C illustrate a moisture content, a degree of swelling and a water resistance of hybrid films according to an example embodiment;

FIG. 16A is a graph illustrating a relationship between a transmittance and a UV-Vis absorbance of hybrid films of examples and a comparative example according to an example embodiment, and FIG. 16B is a graph illustrating a relationship between a wavelength and a UV-Vis absorbance of hybrid films of examples and a comparative example according to an example embodiment;

FIGS. 17A, 17B and 17C illustrate a degree of swelling of hybrid films for each pH condition according to an example embodiment;

FIGS. 18A, 18B and 18C are graphs illustrating bovine serum albumin (BSA) drug release properties of hybrid films for each pH condition according to an example embodiment;

FIGS. 19A, 19B and 19C are graphs illustrating tetracycline (TCN) drug release properties of hybrid films for each pH condition according to an example embodiment; and

FIGS. 20A, 20B and 20C are graphs illustrating dimethyloxaloylglycine (DMOG) drug release properties of hybrid films for each pH condition according to an example embodiment.

### DETAILED DESCRIPTION

Hereinafter, example embodiments of the present disclosure will be described in detail with reference to the accompanying drawings.

Various modifications may be made to example embodiments. However, it should be understood that these embodiments are not construed as limited to the illustrated forms and include all changes, equivalents or alternatives within the idea and the technical scope of this disclosure.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching with contextual meanings in the related art and are not to be construed as an ideal or excessively formal meaning unless otherwise defined herein.

Also, in describing of example embodiments, detailed description of well-known related structures or functions will be omitted when it is deemed that such description will cause ambiguous interpretation of the present disclosure.

Polymer-Ceramic Hybrid Film

According to an example embodiment, there is provided a polymer-ceramic hybrid film including: a biocompatible polymer including a carboxyl group and a hydroxyl group; calcium phosphate; and a divalent metal ion.

Elasticity and mechanical properties of the hybrid film may be determined based on a ratio of the biocompatible polymer and calcium phosphate and a film formation induction process (a film manufacturing process speed, a film thickness, and the like). For example, when the biocompatible polymer and the calcium phosphate are mixed at a weight ratio of 20:1 to 8:1, the hybrid film may exhibit excellent elasticity. When the biocompatible polymer and the calcium phosphate are mixed at a weight ratio of 1:2 to 1:20, the hybrid film may exhibit excellent physical properties. When the biocompatible polymer and the calcium phosphate are mixed at a weight ratio of 5:1 to 1:1, a balance between elasticity and mechanical properties of a hybrid film may be maintained.

When the biocompatible polymer and the calcium phosphate are mixed at a weight ratio of 20:1 to 1:20, a shape of the hybrid film including the biocompatible polymer and the calcium phosphate may be maintained for a long period of time.

The biocompatible polymer may be at least one selected from the group consisting of alginate, hyaluronic acid, chondroitin sulfate, carboxycellulose and collagen, and may desirably be alginate, but is not limited thereto.

To form a cross-linkage with a hydroxyl group of the alginate, a ceramic may be used. The ceramic is not particularly limited and may be used if the ceramic is an inorganic material, and may include, for example, calcium phosphate. The calcium phosphate may be monocalcium phosphate, dicalcium phosphate, tricalcium phosphate, tetracalcium phosphate, or hydroxyapatite, but may desirably be tricalcium phosphate (TCP). Here, a cross-linkage between the hydroxyl group of the alginate and the calcium phosphate may be a hydrogen bond.

Also, the ceramic may be titanium oxide or silicon oxide and is not particularly limited. For example, titanium oxide may desirably be titanium dioxide (TiO₂), and silicon oxide may be silicon dioxide (SiO₂).

A carboxyl group of the alginate may be cross-linked with the divalent metal ion. Here, the divalent metal ion may be Ca²⁺, Be²⁺, Mg²⁺, Sr²⁺, Ba²⁺, Ra²⁺ or a combination thereof, but may desirably be calcium ion (Ca²⁺). A cross-linkage between the carboxyl group of the alginate and the divalent metal ion may be an ionic bond.

In other words, a double cross-linkage of the cross-linkage between the hydroxyl group of the alginate and the calcium phosphate and the cross-linkage between the carboxyl group of the alginate and the divalent metal ion may be formed.

The hybrid film may contain a drug and perform an in-vivo drug delivery function. Here, the hybrid film may exhibit pH-dependent drug release properties.

For example, the hybrid film may slowly release a drug in an acidic condition, that is, low pH, and may rapidly release a drug in a basic condition, that is, high pH. In other words, drug release properties may be adjusted differently based on a pH environment to which the hybrid film is applied, and thus a hybrid film may be selected and applied based on pH of an applied part.

Method for Manufacturing Polymer-Ceramic Hybrid Film

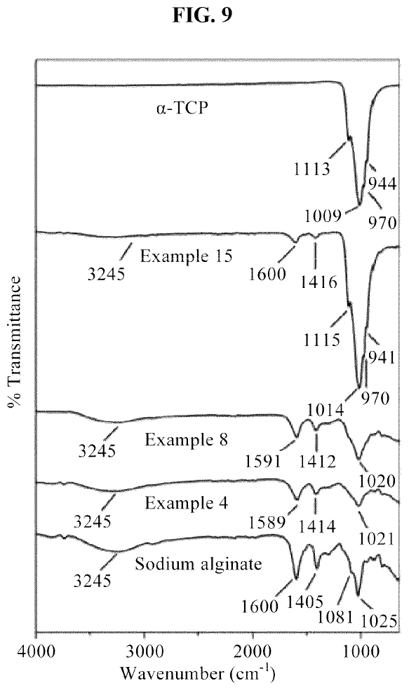

FIG. 9 illustrates a process of manufacturing a polymer-ceramic hybrid film and an arrangement of particles in a film according to an example embodiment.

Referring to FIG. 9, there is provided a method for manufacturing a polymer-ceramic hybrid film, the method including: step (a) of preparing a hybrid solution in which a biocompatible polymer including a carboxyl group and a hydroxyl group is mixed with calcium phosphate; step (b) of inducing an arrangement of particles in the hybrid solution; and step (c) of mixing the hybrid solution with a divalent metal ion solution.

In step (a), a mixing ratio of the biocompatible polymer and the calcium phosphate may be in the range of 20:1 to 8:1, 5:1 to 1:1, or 1:2 to 1:20, based on use of the hybrid film, that is, desired levels of elasticity and mechanical properties. An effect based on each mixing ratio is the same as described above.

The biocompatible polymer in step (a) may be at least one selected from the group consisting of alginate, hyaluronic acid, chondroitin sulfate, carboxycellulose and collagen, and may desirably be alginate, but is not limited thereto.

In step (a), the alginate may be mixed in a solution state, may have a concentration of 1% to 10%, 2.5% to 8.5%, or 5% to 7%, and may desirably have a concentration of about 6%. To increase elasticity, it is desirable to use alginate having a high molecular weight, but example embodiments are not limited thereto.

The biocompatible polymer and ceramic may be mixed by a scheme of preparing each of the biocompatible polymer and ceramic as a solution, and mixing both solutions, and may be prepared as suspensions by the above mixing.

In the hybrid solution prepared in step (a), a hydroxyl group of the alginate may be cross-linked with the calcium phosphate. Here, the calcium phosphate may be tricalcium phosphate (TCP). A type of ceramics that may be used in addition to the calcium phosphate is the same as described above.

Also, the calcium phosphate mixed in step (a) may have various particle sizes, for example, a size ranging from nano-size to micro-size, and may have a particle size of 0.5 to 10 but example embodiments are not limited thereto.

In step (b), an arrangement of particles, for example, calcium phosphate particles and the biocompatible polymer, in the hybrid solution may be induced to enhance crystallinity. Here, an arrangement of internal particles may be induced by screeding the hybrid solution on a support.

A term “screeding” used herein is a process for inducing an arrangement of ceramic particles and smoothing a surface, and refers to a process of applying the hybrid solution onto a support, such as a slide glass, and physically pushing the hybrid solution using a cover, such as a cover glass.

When an arrangement of particles in the hybrid film is induced through the screeding, a certain space may be secured in a biocompatible polymer chain forming a bond to the calcium phosphate, and thus penetration of the divalent metal ion that will be described below and an additional cross-linkage based on this may be easily performed.

Here, a screeding speed may be in the range of 5 cm²/s to 10 cm²/s. The screeding speed may refer to a speed at which the cover is pushed. When the screeding speed is less than 5 cm²/s under the above-described concentration condition of the hybrid solution, a particle arrangement may not be sufficiently induced. When the screeding speed is greater than 10 cm²/s, a cross-linkage between the biocompatible polymer and calcium phosphate may not be induced in an optimal state, which may lead to insufficient elasticity and strength of a film.

The divalent metal ion solution of step (c) may have a concentration of 0.05 M to 5 M, desirably 0.075 M to 1 M, and more desirably 0.1 M. Calcium ions may be gelled by curing a biocompatible polymer-ceramic hybrid solution, and a biocompatible polymer-ceramic hybrid film may be manufactured through a sufficient gelation process more rapidly than when having the above-described concentration range.

In the gel prepared in step (c), a carboxyl group of the alginate may be cross-linked with the divalent metal ion. The divalent metal ion may be Ca²⁺, Be²⁺, Mg²⁺, Sr²⁺, Ba²⁺, Ra²⁺ or a combination thereof, but may desirably be calcium ion (Ca²⁺). A cross-linkage between the carboxyl group of the alginate and the divalent metal ion may be an ionic bond, and thus the hybrid solution may be gelled.

A gelation process of step (c) may be performed for a period of 0.1 minutes to 30 minutes, 1 minutes to 25 minutes, or 3 minutes to 15 minutes, but example embodiments are not particularly limited thereto, and desirably be performed for a period of 5 minutes to 10 minutes.

After step (c), the gel may be dried and separated from the support, to finally obtain an elastic polymer-ceramic hybrid film. For example, the drying may be performed in a vacuum oven for about 48 hours.

Hereinafter, the present disclosure will be described in detail with reference to examples. However, the following examples are illustrative only, and do not limit the scope of the present disclosure.

### Preparation Example 1: Preparation of Biocompatible Polymer-Ceramic Mixed Suspension (A1)

α-tricalcium phosphate (α-TCP) powders were prepared based on a known method (Kim H. W. et al., J. Mater. Sci. Mater. Med., 2010, 21, 3019-27). First, commercial calcium carbonate (Sigma Aldrich) and anhydrous dicalcium phosphate (Sigma Aldrich) were mixed, and then heated and reacted at about 1400° C. for about 3 hours, and quickly frozen in air, to form α-TCP powders. The formed α-TCP powders were milled by a ball, sieved by a sieve of about 150 μm, and separately kept in a vacuum state.

Also, 0.3 g of sodium alginate was dissolved in 5 ml of double distilled deionized water (D.D.W) to prepare a 6% sodium alginate solution.

The separately kept calcium phosphate powders and the prepared alginate solution were mixed at a weight ratio of 20:1, and an ultrasonic wave was applied (Sonics, Vibra Cell) to prepare a polymer-ceramic mixed suspension (A1).

### Preparation Example 2: Preparation of Biocompatible Polymer-Ceramic Mixed Suspension (A2)

A polymer-ceramic mixed suspension (A2) was prepared in the same manner as in Preparation Example 1 except that an alginate solution and calcium phosphate powder were mixed at a weight ratio of 15:1.

### Preparation Example 3: Preparation of Biocompatible Polymer-Ceramic Mixed Suspension (A3)

A polymer-ceramic mixed suspension (A3) was prepared in the same manner as in Preparation Example 1 except that an alginate solution and calcium phosphate powder were mixed at a weight ratio of 12:1.

### Preparation Example 4: Preparation of Biocompatible Polymer-Ceramic Mixed Suspension (A4)

A polymer-ceramic mixed suspension (A4) was prepared in the same manner as in Preparation Example 1 except that an alginate solution and calcium phosphate powder were mixed at a weight ratio of 10:1.

### Preparation Example 5: Preparation of Biocompatible Polymer-Ceramic Mixed Suspension (A5)

A polymer-ceramic mixed suspension (A5) was prepared in the same manner as in Preparation Example 1 except that an alginate solution and calcium phosphate powder were mixed at a weight ratio of 8:1.

### Preparation Example 6: Preparation of Biocompatible Polymer-Ceramic Mixed Suspension (A6)

A polymer-ceramic mixed suspension (A6) was prepared in the same manner as in Preparation Example 1 except that an alginate solution and calcium phosphate powder were mixed at a weight ratio of 5:1.

### Preparation Example 7: Preparation of Biocompatible Polymer-Ceramic Mixed Suspension (A7)

A polymer-ceramic mixed suspension (A7) was prepared in the same manner as in Preparation Example 1 except that an alginate solution and calcium phosphate powder were mixed at a weight ratio of 3:1.

### Preparation Example 8: Preparation of Biocompatible Polymer-Ceramic Mixed Suspension (A8)

A polymer-ceramic mixed suspension (A8) was prepared in the same manner as in Preparation Example 1 except that an alginate solution and calcium phosphate powder were mixed at a weight ratio of 2:1.

### Preparation Example 9: Preparation of Biocompatible Polymer-Ceramic Mixed Suspension (A9)

A polymer-ceramic mixed suspension (A9) was prepared in the same manner as in Preparation Example 1 except that an alginate solution and calcium phosphate powder were mixed at a weight ratio of 1:1.

### Preparation Example 10: Preparation of Biocompatible Polymer-Ceramic Mixed Suspension (A10)

A polymer-ceramic mixed suspension (A10) was prepared in the same manner as in Preparation Example 1 except that an alginate solution and calcium phosphate powder were mixed at a weight ratio of 1:2.

### Preparation Example 11: Preparation of Biocompatible Polymer-Ceramic Mixed Suspension (A11)

A polymer-ceramic mixed suspension (A11) was prepared in the same manner as in Preparation Example 1 except that an alginate solution and calcium phosphate powder were mixed at a weight ratio of 1:3.

### Preparation Example 12: Preparation of Biocompatible Polymer-Ceramic Mixed Suspension (A12)

A polymer-ceramic mixed suspension (A12) was prepared in the same manner as in Preparation Example 1 except that an alginate solution and calcium phosphate powder were mixed at a weight ratio of 1:4.

### Preparation Example 13: Preparation of Biocompatible Polymer-Ceramic Mixed Suspension (A13)

A polymer-ceramic mixed suspension (A13) was prepared in the same manner as in Preparation Example 1 except that an alginate solution and calcium phosphate powder were mixed at a weight ratio of 1:6.

### Preparation Example 14: Preparation of Biocompatible Polymer-Ceramic Mixed Suspension (A14)

A polymer-ceramic mixed suspension (A14) was prepared in the same manner as in Preparation Example 1 except that an alginate solution and calcium phosphate powder were mixed at a weight ratio of 1:8.

### Preparation Example 15: Preparation of Biocompatible Polymer-Ceramic Mixed Suspension (A15)

A polymer-ceramic mixed suspension (A15) was prepared in the same manner as in Preparation Example 1 except that an alginate solution and calcium phosphate powder were mixed at a weight ratio of 1:10.

### Preparation Example 16: Preparation of Biocompatible Polymer-Ceramic Mixed Suspension (A16)

A polymer-ceramic mixed suspension (A16) was prepared in the same manner as in Preparation Example 1 except that an alginate solution and calcium phosphate powder were mixed at a weight ratio of 1:12.

### Preparation Example 17: Preparation of Biocompatible Polymer-Ceramic Mixed Suspension (A17)

A polymer-ceramic mixed suspension (A17) was prepared in the same manner as in Preparation Example 1 except that an alginate solution and calcium phosphate powder were mixed at a weight ratio of 1:14.

### Preparation Example 18: Preparation of Biocompatible Polymer-Ceramic Mixed Suspension (A18)

A polymer-ceramic mixed suspension (A18) was prepared in the same manner as in Preparation Example 1 except that an alginate solution and calcium phosphate powder were mixed at a weight ratio of 1:16.

### Preparation Example 19: Preparation of Biocompatible Polymer-Ceramic Mixed Suspension (A19)

A polymer-ceramic mixed suspension (A19) was prepared in the same manner as in Preparation Example 1 except that an alginate solution and calcium phosphate powder were mixed at a weight ratio of 1:120.

### Preparation Example 20: Preparation of Biocompatible Polymer Suspension (B1)

A polymer suspension (B1) was prepared in the same manner as in Preparation Example 1 except that a calcium phosphate powder was not included.

### Example 1: Manufacturing of Biocompatible Polymer-Ceramic Hybrid Film

First, the suspension (A1) prepared in Preparation Example 1 was applied to a slide glass (7.5×2.5 cm²), a screeding process was performed at a speed of 7.4±0.5 cm²/s, and an arrangement of particles was induced. Then, the slide glass was immersed in a 0.1 M aqueous solution of calcium chloride (CaCl₂)) for 30 minutes and an ionic cross-linkage was formed, to prepare a hydrogel. The hydrogel was separated from the slide glass, washed three times with distilled water, and dried in a vacuum oven for 48 hours on a separate slide glass, to manufacture a biocompatible polymer-ceramic hybrid film.

### Examples 2 to 19 and Comparative Example: Manufacturing of Biocompatible Films

Biocompatible films were manufactured in the same manner as in Example 1 except that a type of the suspensions prepared based on the above preparation examples is adjusted as shown in the following Table 1.

TABLE 1

| | Examples | | | | | | | | | |
|---|---|---|---|---|---|---|---|---|---|---|
| Classification | 1 | 2 | 3 | 4 | 5 | 6 | 7 | 8 | 9 | 10 |
| Type of | A1 | A2 | A3 | A4 | A5 | A6 | A7 | A8 | A9 | A10 |
| suspensions | | | | | | | | | | |
| (Control | | | | | | | | | | |
| group) | | | | | | | | | | |

| | Examples | | | | | | | | | Comparative |
|---|---|---|---|---|---|---|---|---|---|---|
| Classification | 11 | 12 | 13 | 14 | 15 | 16 | 17 | 18 | 19 | example |
| Type of | A11 | A12 | A13 | A14 | A15 | A16 | A17 | A18 | A19 | B1 |
| suspensions | | | | | | | | | | |
| (Control | | | | | | | | | | |
| group) | | | | | | | | | | |

### Experimental Example 1: Observation of Appearance of Hybrid Film and Simple Evaluation

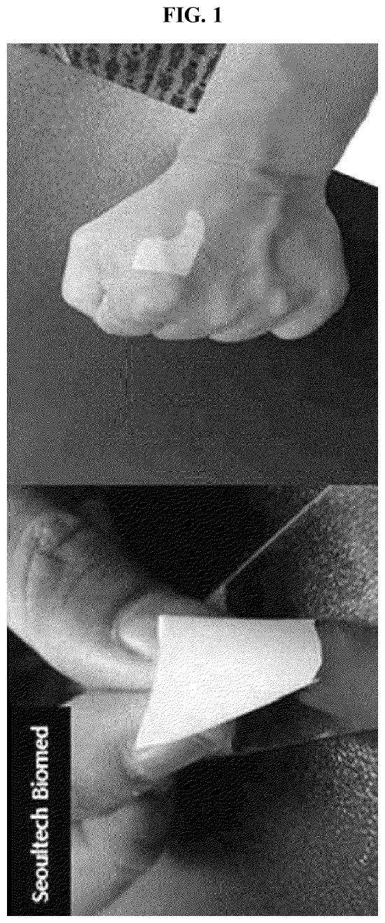

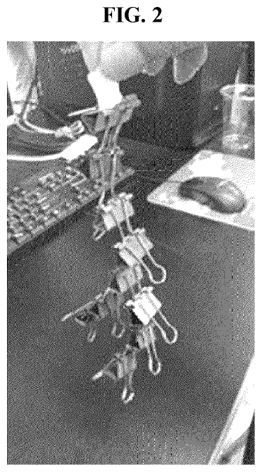

The biocompatible films prepared in Examples 1 to 19 and comparative example were observed with naked eyes, and elasticity and mechanical properties were evaluated. An elasticity evaluation was conducted through a simple experiment using a method shown in FIG. 1, and mechanical properties were evaluated through a simple experiment using a method shown in FIG. 2, based on the following criteria.

The biocompatible films prepared in Examples 1 to 19 and comparative example were observed with naked eyes, and elasticity and mechanical properties were evaluated. An elasticity evaluation was conducted through a simple experiment using a method shown in FIG. 1, and mechanical properties were evaluated through a simple experiment using a method shown in FIG. 2, based on the following criteria.

Evaluation criteria for elastic properties and film shape retention for each of the examples and comparative example are as follows:

<Evaluation Criteria of Elasticity>
O: Elastic properties were observed
X: Elastic properties were not observed

<Evaluation Criteria of Mechanical Properties>
O: Mechanical properties were observed (that is, a film was not torn and kept in the simple experiment)
X: Mechanical properties were not observed (that is, a film was torn in the simple experiment)

<Evaluation Criteria of Film Shape Retention>
O: A shape of a film was observed to be maintained
X: A shape of a film was not maintained and the film was cracked or torn

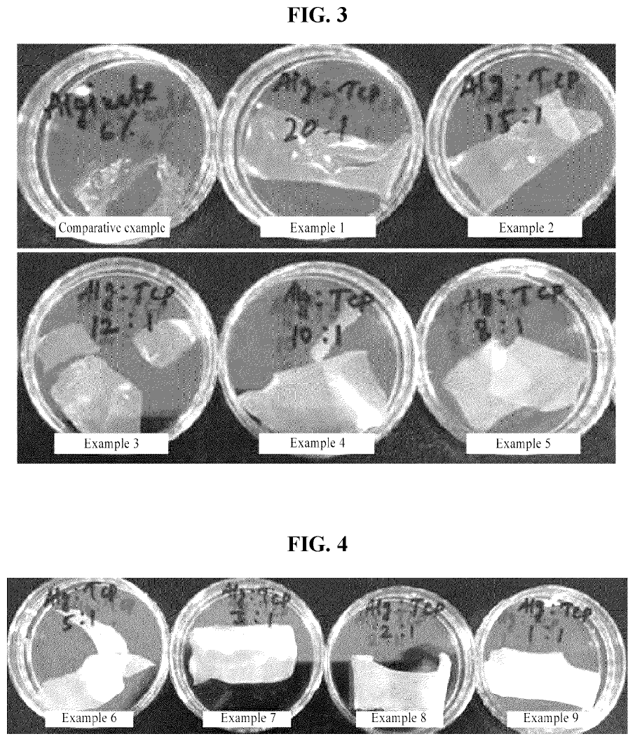

Actually observed photographs are shown in FIGS. 3 through 6.

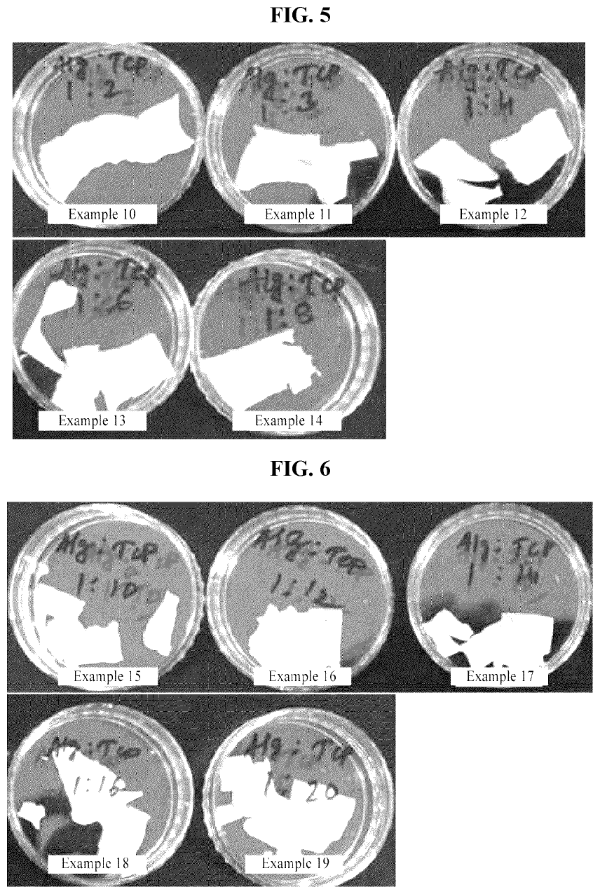

More specifically, FIG. 3 illustrates photographs of results for Examples 1 to 5 and the comparative example. FIG. 4 illustrates photographs of results for Examples 6 to 9. FIG. 5 illustrates photographs of results for Examples 10 to 14. FIG. 6 illustrates photographs of results for Examples 15 to 19.

Also, results obtained by evaluations based on the evaluation criteria are shown in Table 2 below.

TABLE 2

| | Examples | | | | | | | | | |
|---|---|---|---|---|---|---|---|---|---|---|
| Classification | 1 | 2 | 3 | 4 | 5 | 6 | 7 | 8 | 9 | 10 |
| Elasticity | ◯ | ◯ | ◯ | ◯ | ◯ | ◯ | ◯ | ◯ | ◯ | X |
| Mechanical | X | X | X | X | X | ◯ | ◯ | ◯ | ◯ | ◯ |
| properties | | | | | | | | | | |
| Film shape | ◯ | ◯ | ◯ | ◯ | ◯ | ◯ | ◯ | ◯ | ◯ | ◯ |
| retention | | | | | | | | | | |

| | Examples | | | | | | | | | Comparative |
|---|---|---|---|---|---|---|---|---|---|---|
| Classification | 11 | 12 | 13 | 14 | 15 | 16 | 17 | 18 | 19 | example |
| Elasticity | X | X | X | X | X | X | X | X | X | X |
| Mechanical | ◯ | ◯ | ◯ | ◯ | ◯ | ◯ | ◯ | ◯ | ◯ | ◯ |
| properties | | | | | | | | | | |
| Film shape | ◯ | ◯ | ◯ | ◯ | ◯ | ◯ | ◯ | ◯ | ◯ | X |
| retention | | | | | | | | | | |

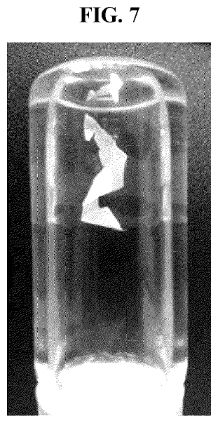

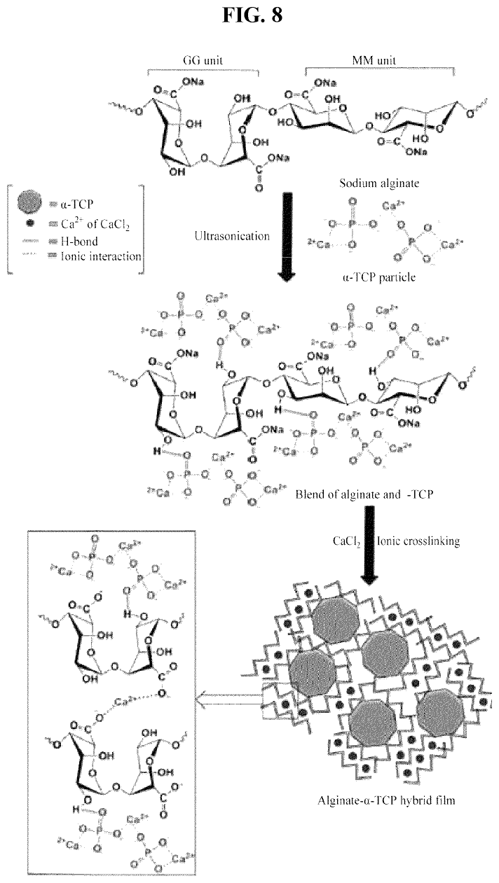

Also, FIG. 7 is a photograph showing that a shape of a hybrid film according to an example embodiment is maintained even after 12 days elapsed.

As shown in Table 2, and FIGS. 3 to 7, the shape of the polymer-ceramic hybrid film according to an example embodiment may be maintained for a long period of time while elasticity and mechanical properties are controlled, by adjusting a mixing ratio of tricalcium phosphate and alginate that is a biocompatible polymer. Thus, the hybrid film may be applied to drug carriers, artificial cartilages, and the like as well as to medical materials, such as medical patches, dental impression materials and implant materials, and may also be applied to various fields, such as cosmetic containers, agricultural biodegradable materials and food packaging containers. Furthermore, a hydrogel that may be obtained in a process of manufacturing the hybrid film may be very useful as materials for 3D printing.

### Experimental Example 2: Verification of Molecular Structure Properties of Hybrid Films

To verify molecular structure characteristics of the hybrid films of Examples 4, 8 and 15, ATR-FTIR, ¹³C NMR, XRD and TGA analyses were performed. ATR-FTIR spectra of each of the hybrid films, sodium alginate and tricalcium phosphate were measured in a wavelength range of 650 cm⁻¹ to 4,000 cm⁻¹ using an ATR-FTIR spectrometer (Travel IR, Smiths Detection). ¹³C NMR analyses of each of the hybrid films and sodium alginate were performed using an NMR spectrometer (DD2 700, Agilent technologies), and XRD analyses thereof were performed using an X-ray diffractometer (Bruker DE/D8 Advance, Bruker). Also, TGA analyses of each of the hybrid films and sodium alginate were performed using a thermogravimetric analyzer (DTG-60, Shimadzu). All of the analyses were performed at a scan speed of 5° C./min under a nitrogen atmosphere. The ATR-FTIR, ¹³C NMR, XRD and TGA analysis results are shown in FIGS. 9 through 12, respectively.

As shown in the ATR-FTIR results of FIG. 9, it may be confirmed that a carboxylic acid signal intensity of 1,600 cm⁻¹ and 1,405 cm⁻¹ in the hybrid films of Examples 4, 8 and 15 is sharply reduced in comparison to the sodium alginate, because a cross-linkage (ionic bond) between a calcium ion and a carboxyl group of the alginate is formed. Also, a wide signal intensity around 3,245 cm⁻¹ corresponding to a hydroxyl group in Examples 4, 8 and 15 indicates that a cross-linkage (hydrogen bond) between a hydroxyl group of the alginate and tricalcium phosphate is formed.

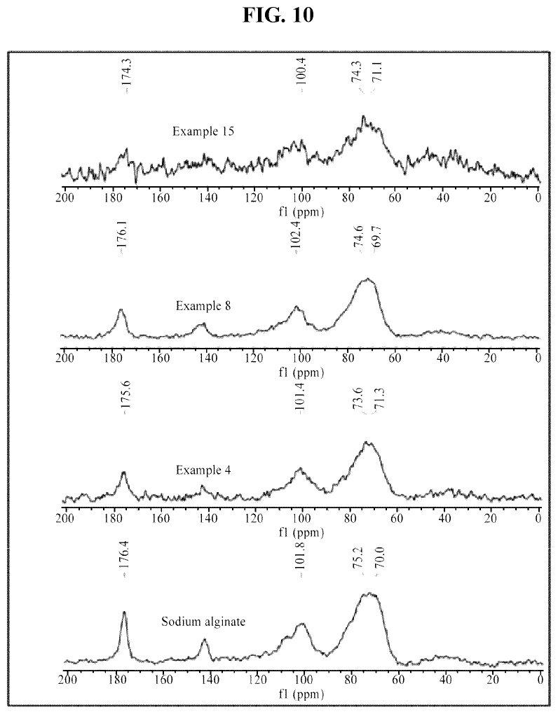

As shown in the ¹³C NMR results of FIG. 10, it may be confirmed that an intensity of a 176.4 ppm signal indicating a presence of carbonyl carbon of sodium alginate decreases when mixed with tricalcium phosphate, and thus it may be found that a cross-linkage (ionic bond) between a carboxyl group of the alginate and calcium ion is formed.

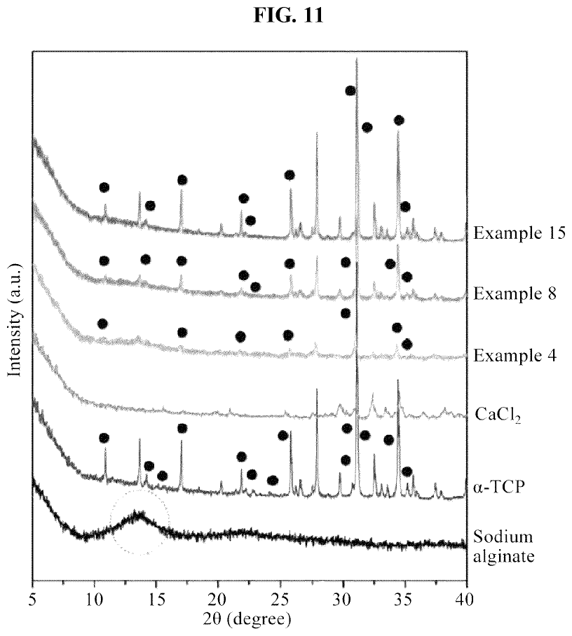

As shown in the XRD results of FIG. 11, it may be confirmed that an intensity of a signal at 2θ=13.7° indicating a presence of alginate gradually decreases based on an increase in a concentration and mixing with tricalcium phosphate, thereby reducing crystallinity of the alginate. The above results suggest that there is excellent miscibility between the alginate and tricalcium phosphate. Also, as shown in the results of Examples 4, 8 and 15, it may be confirmed that a signal intensity thereof increases as a concentration of tricalcium phosphate increases, and the above results are analyzed to indicate that crystallinity of tricalcium phosphate is maintained so as to have an influence on mechanical properties of a hybrid film.

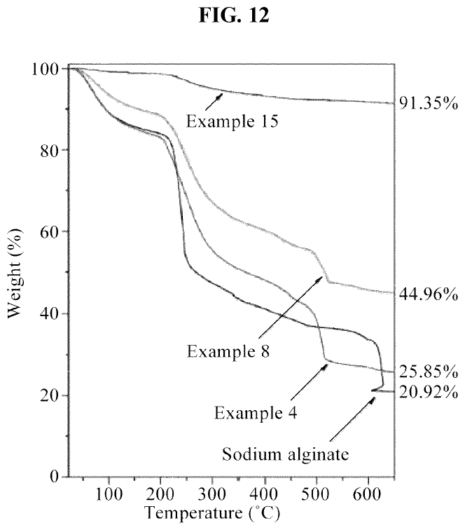

As shown in the TGA results of FIG. 12, a second region (186° C. to 377° C.) in which a bond of chains is broken among weight loss regions of alginate is related to thermal stability, and it is confirmed that a corresponding region of a hybrid film is formed at a temperature of 182° C. to 407° C. and that a weight loss rate decreases as a content of tricalcium phosphate increases. Thus, it may be found that the tricalcium phosphate enhances thermal stability of the alginate.

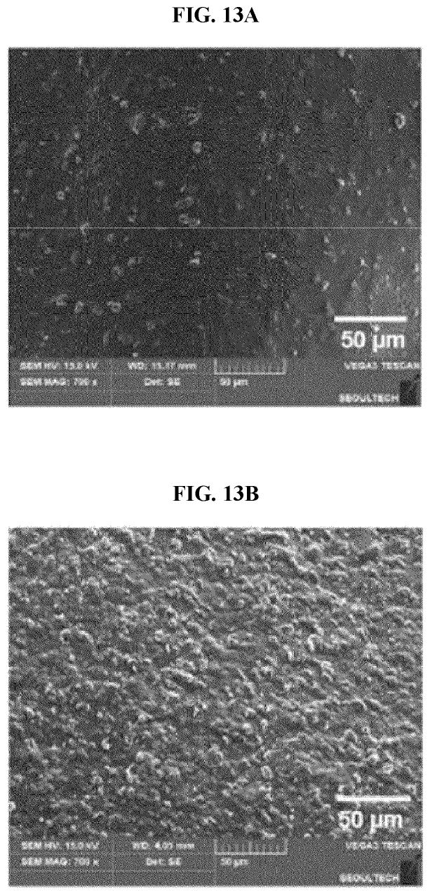

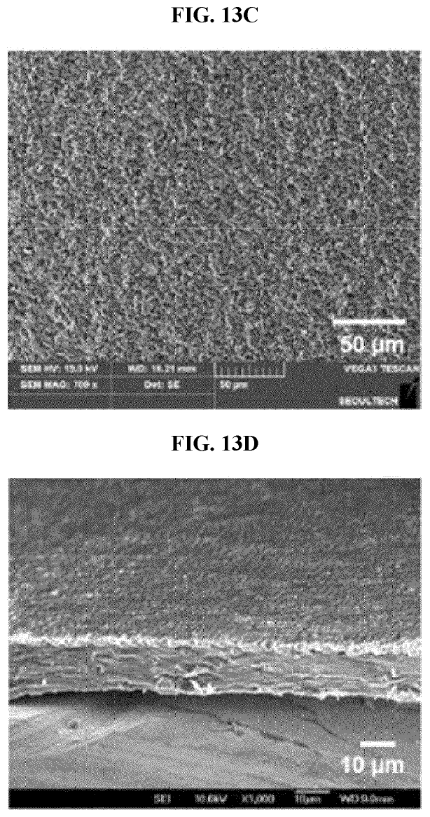

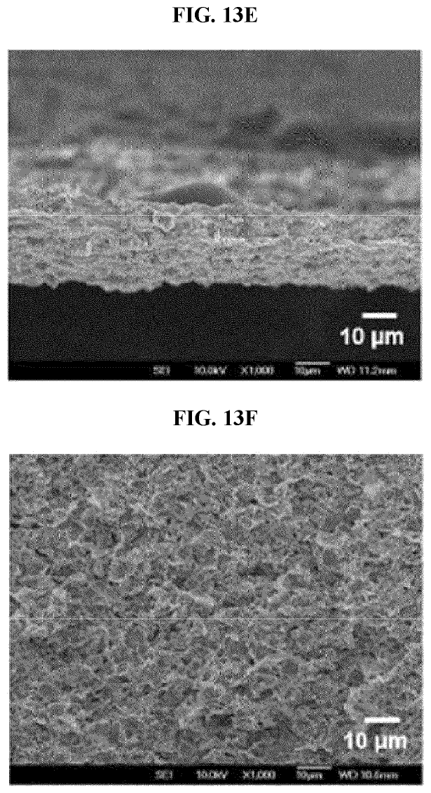

To observe surface properties of the hybrid films of Examples 4, 8 and 15, a surface of each of the hybrid films was observed using a SEM (TESCAN VEGA3, Tescan), cross-sectional areas were observed using a FESEM (JSM-6700F, JEOL), and results thereof are shown in FIGS. 13A through 13F. FIGS. 13A, 13B and 13C illustrate SEM images of Examples 4, 8 and 15, and FIGS. 13D, 13E and 13F illustrate FESEM images thereof.

Referring to FIGS. 13A through 13F, it may be confirmed that a cross-linkage with alginate is increased by increasing a content of tricalcium phosphate so that tricalcium phosphate particles are clearly shown on a surface of the alginate.

### Experimental Example 3: Evaluation of Mechanical Properties of Hybrid Films

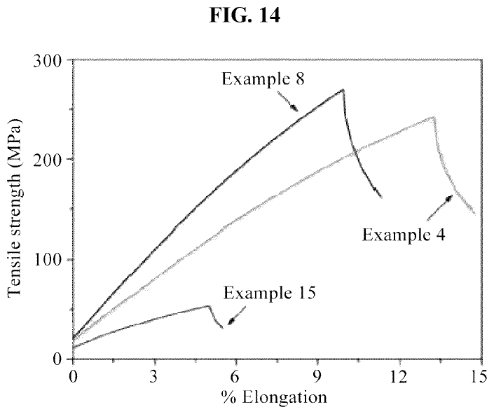

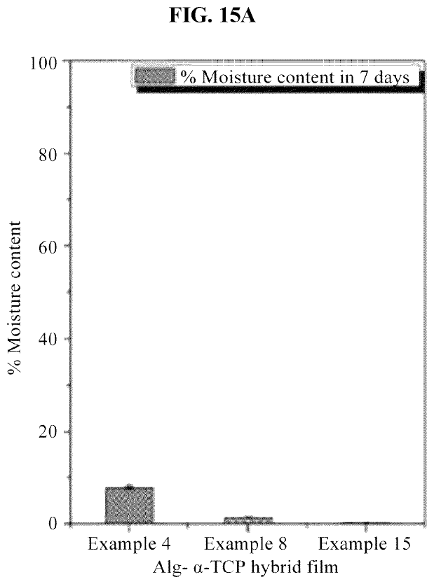

To evaluate mechanical properties of the hybrid films according to Examples 4, 8 and 15, a tensile strength and elongation rate were measured using a fatigue tester (E3000LT, INSTRON) according to the ASTM standard at 25° C. under a humidity condition of 60-65%. Specifically, each of the hybrid films was cut in a form of a strip (5×1 cm²) and a grip was formed, to prepare a test specimen. A gage length of the specimen and a distance between grips were set to 15 mm and 20 mm, and a crosshead speed was set to 1 mm/s. The measurement results are shown in Table 3 below, and a relationship between a tensile strength and elongation rate is shown in FIG. 14.

TABLE 3

| | Specimen thickness | Elongation rate | Tensile strength |
|---|---|---|---|
| Classification | (mm) | (%) | (MPa) |
| Example 4 | 0.10 ± 0.01 | 13.23 | 254.51 |
| Example 8 | 0.10 ± 0.01 | 10.50 | 257.52 |
| Example 15 | 0.10 ± 0.01 | 4.44 | 38.48 |

Referring to Table 3 and FIG. 14, it may be confirmed that the hybrid films of Examples 4 and 8 have similar tensile strengths and similar elongation rates, which are greater than the tensile strength and elongation rate of the hybrid film of Example 15. The above results indicate that the hybrid films of Examples 4 and 8 may be utilized for food package containers or medical materials, such as dental elastic impression materials, due to their excellent elasticity.

The hybrid film of Example 15 has a low tensile strength value, because a specimen was easily broken due to a low elongation rate and it was impossible to further apply a tensile load. Thus, the hybrid film of Example 15 may be usefully applied to a food package container that requires only mechanical properties instead of elasticity.

### Experimental Example 4: Evaluation of Moisture Content, Degree of Swelling, and Water Resistance of Hybrid Films

To verify properties associated with moisture of the hybrid films of Examples 4, 8 and 15, a moisture content, a degree of swelling and water resistance were evaluated. Release properties of a material, for example, a drug, contained in a film may be determined based on a moisture content, a degree of swelling and water resistance of a hybrid film, and thus the moisture content, the degree of swelling and the water resistance may be utilized as indirect indices therefor.

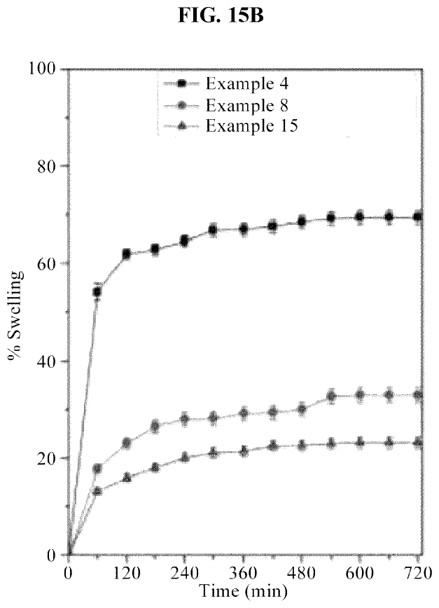

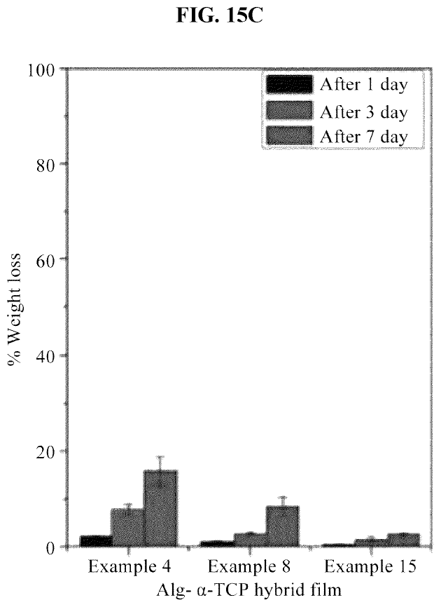

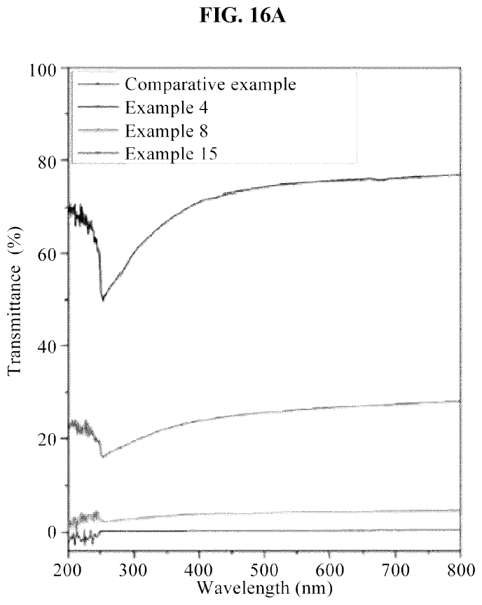

First, a specimen (4×2 cm²) obtained by cutting and drying each of the hybrid films, weighed, and left in air at 25° C. under a relative humidity condition of 60-65% for 7 days. Each specimen was weighed after 24 hours, a moisture content (%) was calculated using Equation 1 shown below, and the results are shown in FIG. 15A.

Moisture content (%)=(Weight of specimen before being left/Weight of specimen after being left)×100(%) [Equation 1]

Referring to FIG. 15A, it may be found that a moisture content of the hybrid film decreases as a content of tricalcium phosphate increases. This is because in response to an increase in the content of tricalcium phosphate, a space that may accommodate water in a chain of alginate decreases and a content of a hydrophilic hydroxyl group also decreases.

Also, each of the dried specimens (4×2 cm²) was immersed in 50 ml of distilled water and stored at 25° C. for 24 hours. Each of the immersed specimens was removed from the distilled water after 1 hour, moisture was removed and each of the specimens was weighed until a weight reached equilibrium. The degree of swelling (%) was calculated using Equation 2 shown below and the results are shown in FIG. 15B.

Degree of swelling (%)=[(Weight of specimen after immersion−Weight of specimen before immersion)/Weight of specimen before immersion]×100(%) [Equation 2]

Referring to FIG. 15B, it may be confirmed that the degree of swelling decreases as a content of tricalcium phosphate increases. This is because the tricalcium phosphate binds to a hydroxyl group that is a hydrophilic functional group, thereby reducing hydrophilicity of a molecule and an internal space of an alginate chain.

Each of specimens (4×2 cm²) already weighed and the dried was immersed in 50 ml of distilled water and stirred at 25° C. and 100 rpm for 7 days. After 24 hours, 72 hours and 268 hours, each of the specimens was removed from the distilled water, dried at 40° C. for 48 hours, and weighed. The water resistance was measured based on a weight reduction rate (%) calculated using Equation 3 shown below, and the results are shown in FIG. 15C.

Weight reduction rate (%)=[(Weight of first dried specimen−Weight of finally dried specimen)/Weight of first dried specimen]×100(%) [Equation 3]

Referring to FIG. 15C, it may be found that the water resistance is enhanced due to a reduction in the weight reduction rate as a content of tricalcium phosphate increases. This is because tricalcium phosphate present on a surface of alginate effectively prevents permeation of moisture.

The above results indicate that a speed of a material to enter and exit, for example, drug release properties, may be controlled by adjusting an amount of tricalcium phosphate in a film.

### Experimental Example 5: Evaluation of Optical Properties of Hybrid Films

To evaluate optical properties of the hybrid films of Examples 4, 8 and 15, an opacity and a light transmittance were measured. Specifically, a square specimen (2×1 cm²) was prepared by cutting each of the hybrid films, and absorbance and transmittance (%) of each specimen were measured using a UV-Vis spectrophotometer in a wavelength range of 200 nm to 800 nm under an air atmosphere.

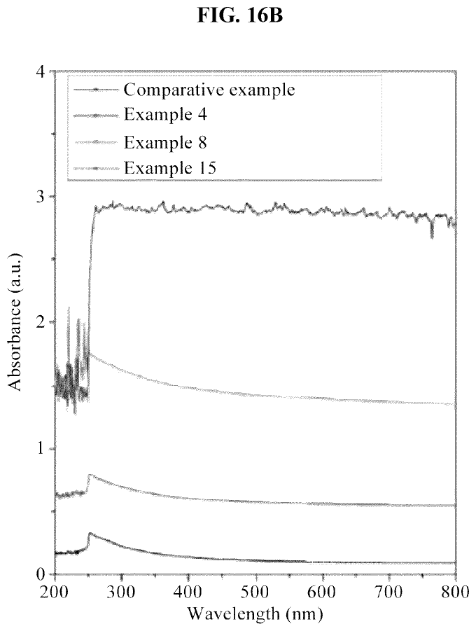

The opacity was calculated using Equation 4 shown below, and the results are shown in Table 4, and FIGS. 16A and 16B. FIG. 16A shows a relationship between a transmittance (%) and a wavelength, and FIG. 16B shows a relationship between an absorbance and a wavelength.

Opacity (%)=(Absorbance at 600 nm/thickness of film)×100(%) [Equation 4]

TABLE 4

| | Specimen thickness | Opacity | Transmittance |
|---|---|---|---|
| Classification | (mm) | (%, at 600 nm) | (%, at 254 nm) |
| 6% alginate | 0.10 ± 0.01 | 1.96 ± 0.12 | 48.58 ± 0.73 |
| Example 4 | 0.10 ± 0.01 | 6.61 ± 0.27 | 16.72 ± 0.59 |
| Example 8 | 0.10 ± 0.01 | 14.01 ± 0.33 | 2.23 ± 0.06 |
| Example 15 | 0.10 ± 0.01 | 28.90 ± 1.72 | 0.40 ± 0.11 |

Referring to Table 4, and FIGS. 16A and 16B, it is confirmed that the hybrid films of Examples 8 and 15 exhibit similar levels of the light transmittance, and have a higher opacity and lower light transmittance than the hybrid film of Example 4 or a film including only alginate.

Thus, when the hybrid films of Examples 8 and 15 are applied to a food package container, destruction of nutrients, such as fat, and the like, from ultraviolet rays may be effectively prevented by blocking light, and in particular, the hybrid film of Example 15 has a more excellent effect.

### Experimental Example 6: Evaluation of Degree of Swelling of Hybrid Films Based on pH Conditions

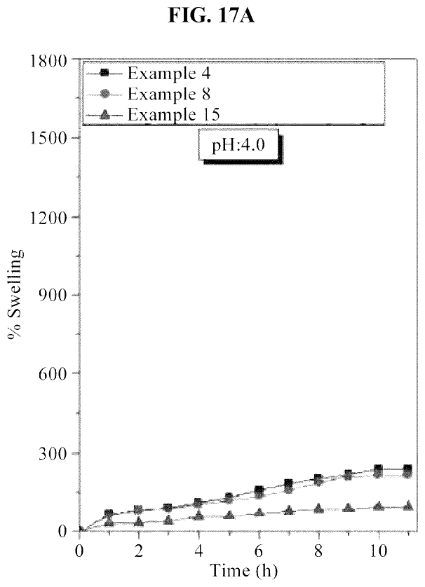

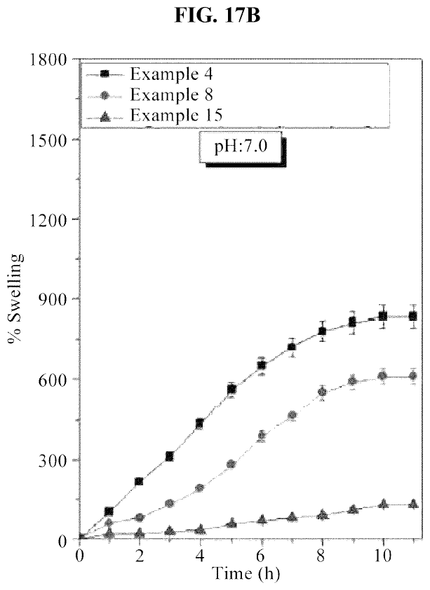

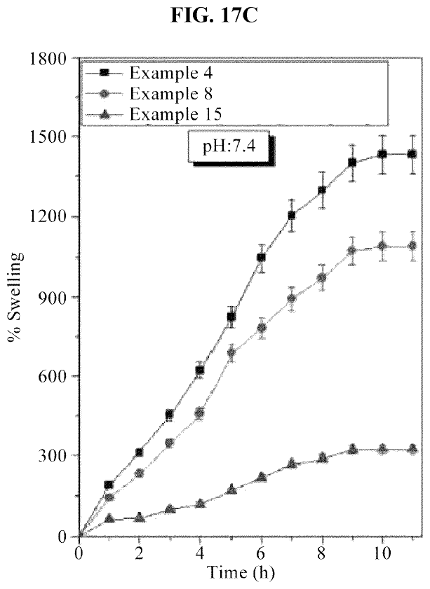

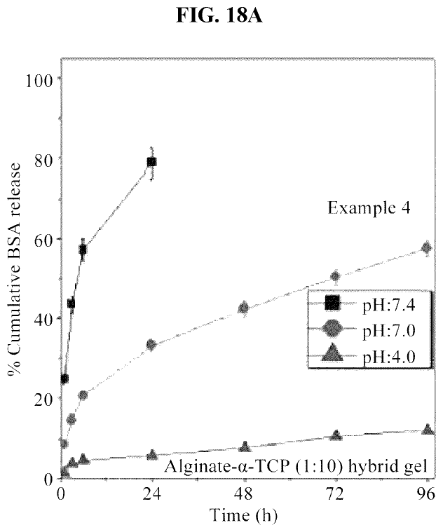

To determine whether a degree of swelling of a hybrid film changes based on pH conditions, a degree of swelling (%) of the hybrid films of Examples 4, 8 and 15 was calculated in the same manner as in Experimental Example 4 while changing pH conditions, and the results are shown in FIGS. 17A, 17B and 17C.

Referring to FIGS. 17A, 17B and 17C, it may be confirmed that the degree of swelling increases depending on pH in all of the hybrid films. This is because an increase in a calcium ion-base bond due to an increase in pH destroys a cross-linkage between a calcium ion-carboxylic acid, thereby increasing an internal space of a film and forming a bond between a dissociated hydrophilic carboxylic acid anion and a water molecule.

Based on the above results, it may be expected that a drug release rate of a hybrid film may increase under a high pH condition and that a drug release rate may decrease in an environment of a low pH, and selective applicability of a hybrid film may be expected due to the above properties.

### Experimental Example 7: Evaluation of Drug Release Properties of Hybrid Films

To evaluate drug release properties of the hybrid films of Examples 4, 8 and 15, a hydrogel was obtained in a process of manufacturing each of the hybrid films and mixed with bovine serum albumin (BSA), tetracycline (TCN) and dimethyloxalyglycine (DMOG), and gel beads were prepared.

Specifically, each hydrogel and each drug (BSA, TCN and DMOG) were put into distilled water and mixed by applying ultrasonic waves at 25° C. Each of the BSA, TCN and DMOG was mixed at a concentration of 4.9×10⁻⁶ mol with 0.165 g of a hydrogel, added to a vial containing 0.1M calcium chloride (CaCl₂)), and cross-linked by applying ultrasonic waves for 30 minutes. Contents in each vial were freeze-dried for 48 hours, to obtain gel beads that have different types of drugs and different contents of alginate and tricalcium phosphate.

To evaluate drug release properties of the gel beads with respect to the BSA, TCN and DMOG, an analysis was performed using a UV-Vis spectrophotometer (BioMate 3S, Thermo Scientific) at 37° C. while changing pH. Specifically, each of the gel beads was dissolved in 10 ml of distilled water, and UV-Vis spectra of a solution were recorded and spectrophotometrically calculated, to derive drug release properties (%).

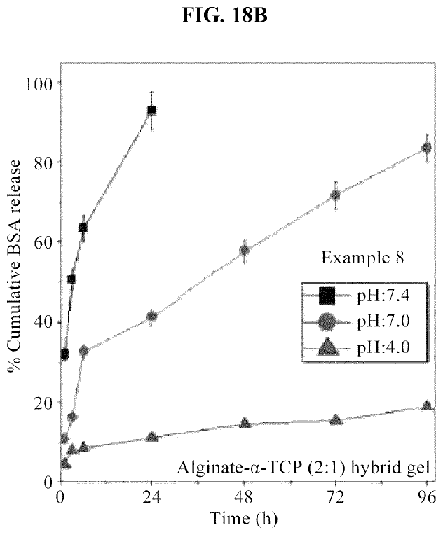

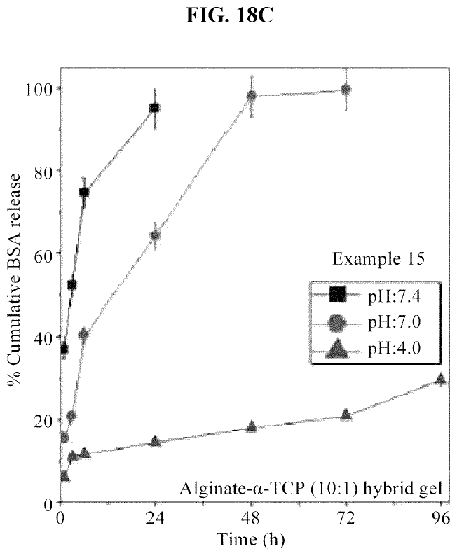

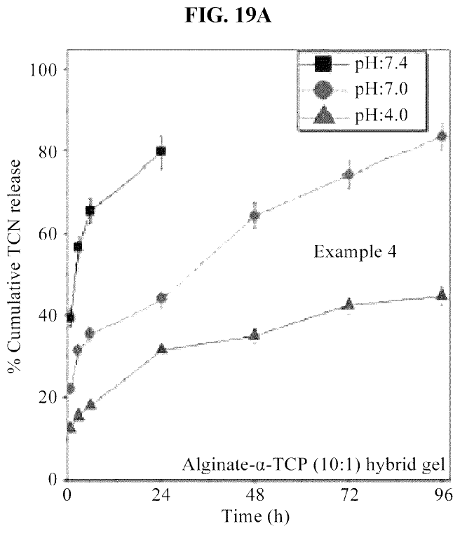

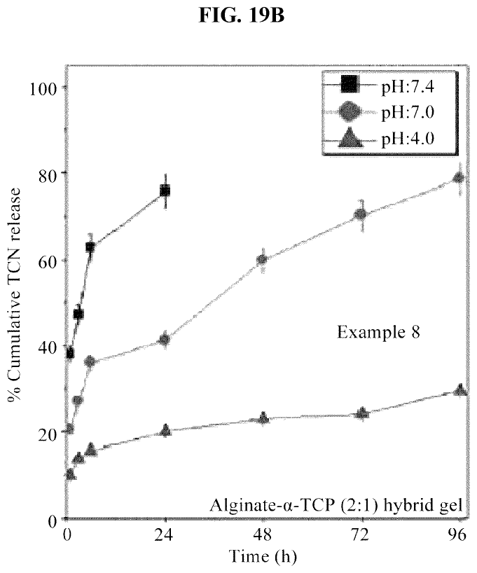

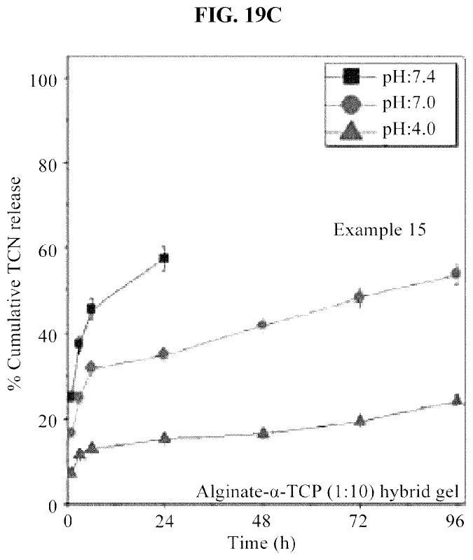

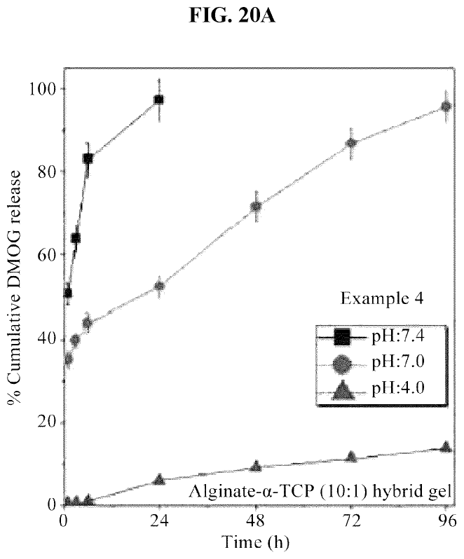

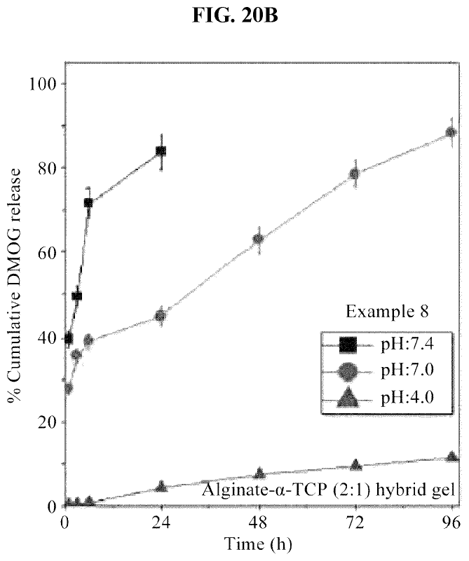

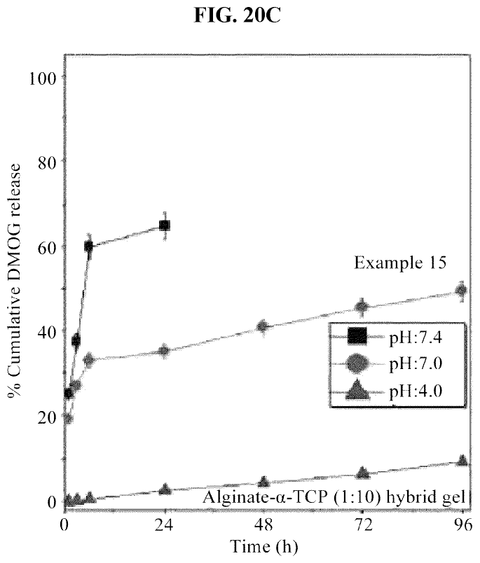

Results of the hybrid films of Examples 4, 8 and 15 with respect to BSA are shown in FIGS. 18A, 18B, 18C, results of the hybrid films with respect to TCN are shown in FIGS. 19A, 19B and 19C, and results of the hybrid films with respect to DMOG are shown in FIGS. 20A, 20B and 20C.

Referring to FIGS. 18A, 18B, 18C, 19A, 19B, 19C, 20A, 20B and 20C, it may be confirmed that drug release rates for all of the BSA, TCN, and DMOG increase as pH increases and that the drug release rates decrease as a content of tricalcium phosphate increases.

Therefore, it may be found that the hybrid film of Example 4 is effective in an environment in which rapid drug release is required under a high pH condition, such as intestine, that the hybrid film of Example 8 is effective in an environment in which a drug is required to be released at an appropriate rate under a neutral pH condition, and that the hybrid film of Example 15 is effective in an environment in which sustained drug release is required under an acidic pH condition, such as stomach.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is not limited by the detailed description, but further supported by the claims and their equivalents, and all variations within the scope of the claims and their equivalents are to be construed as being included in the disclosure.

1. A polymer-ceramic hybrid film comprising:
a biocompatible polymer comprising a carboxyl group and a hydroxyl group;
calcium phosphate; and
a divalent metal ion.

2. The polymer-ceramic hybrid film of claim 1, wherein the biocompatible polymer and the calcium phosphate are mixed at a weight ratio of 20:1 to 8:1.

3. The polymer-ceramic hybrid film of claim 1, wherein the biocompatible polymer and the calcium phosphate are mixed at a weight ratio of 5:1 to 1:1.

4. The polymer-ceramic hybrid film of claim 1, wherein the biocompatible polymer and the calcium phosphate are mixed at a weight ratio of 1:2 to 1:20.

5. The polymer-ceramic hybrid film of claim 1, wherein the biocompatible polymer is alginate.

6. The polymer-ceramic hybrid film of claim 5, wherein a hydroxyl group of the alginate is cross-linked with the calcium phosphate.

7. The polymer-ceramic hybrid film of claim 6, wherein the calcium phosphate is tricalcium phosphate (TCP).

8. The polymer-ceramic hybrid film of claim 5, wherein a carboxyl group of the alginate is cross-linked with the divalent metal ion.

9. The polymer-ceramic hybrid film of claim 8, wherein the divalent metal ion is a calcium ion (Ca²⁺).

10. The polymer-ceramic hybrid film of claim 1, wherein the polymer-ceramic hybrid film exhibits pH-dependent drug release properties.

11. A method for manufacturing a polymer-ceramic hybrid film, the method comprising:
step (a) of preparing a hybrid solution in which a biocompatible polymer comprising a carboxyl group and a hydroxyl group is mixed with calcium phosphate;
step (b) of inducing an arrangement of particles in the hybrid solution; and
step (c) of mixing the hybrid solution with a divalent metal ion solution.

12. The method of claim 11, wherein the biocompatible polymer and the calcium phosphate are mixed at a weight ratio of 20:1 to 8:1.

13. The method of claim 11, wherein the biocompatible polymer and the calcium phosphate are mixed at a weight ratio of 5:1 to 1:1.

14. The method of claim 11, wherein the biocompatible polymer and the calcium phosphate are mixed at a weight ratio of 1:2 to 1:20.

15. The method of claim 11, wherein the biocompatible polymer is alginate.

16. The method of claim 15, wherein a hydroxyl group of the alginate is cross-linked with the calcium phosphate.

17. The method of claim 11, wherein step (b) comprises screeding the hybrid solution on a support.

18. The method of claim 17, wherein a screeding speed is in the range of 5 cm²/s to 10 cm²/s.

19. The method of claim 11, wherein the divalent metal ion solution has a concentration of 0.05 M to 5 M.

20. The method of claim 15, wherein a carboxyl group of the alginate is cross-linked with the divalent metal ion.
